(19) United States
(12) Patent Application Publication
(10) Pub. No.: US 2022/0180260 A1
(43) Pub. Date: Jun. 9, 2022

(54) PERSONAL PROTECTIVE EQUIPMENT-BASED SOCIAL SAFETY NETWORK

(71) Applicant: 3M INNOVATIVE PROPERTIES COMPANY, St. Paul, MN (US)

(72) Inventors: Benjamin W. Watson, Hampshire (GB); Claire R. Donoghue, Reading (GB)

(21) Appl. No.: 17/594,228

(22) PCT Filed: Apr. 6, 2020
(86) PCT No.: PCT/IB2020/053281

§ 371 Date: Oct. 7, 2021

Related U.S. Application Data
(60) Provisional application No. 62/832,230, filed on Apr. 10, 2019.

(51) Int. Cl. G06Q 10/06

(52) U.S. Cl. CPC G06Q 10/0635; G06Q 10/0639; G06Q 10/06315

(57) ABSTRACT

A system includes a plurality of articles of personal protective equipment (PPE) connected to form a network of articles of PPE, wherein each article of PPE is associated with a worker. Each article of PPE receives one or more first safety issue notifications from the network, shares the first safety issue notifications with the worker associated with the article of PPE via an output of the article of PPE, receives safety-related information at an input of the article of PPE, creates a second safety issue notification based on the safety-related information received at the input of the article of PPE, selects one or more of the other articles of PPE to receive the second safety issue notification and transmits the second safety issue notification over the network to the selected articles of PPE.

### TECHNICAL FIELD

The present disclosure relates to industrial personal protective equipment and safety equipment and systems.

### BACKGROUND

Many work environments include hazards that may expose people working within a given environment to a safety event, such as hearing damage, eye damage, a fall, breathing contaminated air, or temperature related injuries (e.g., heat stroke, frostbite, etc.). In many work environments, workers may utilize personal protective equipment (PPE) to help mitigate the consequences of a safety event. Examples of PPEs include respirators, self-contained breathing apparatuses, welding helmets, earmuffs, eyewear and the like. Such equipment often is, however, adapted to the work each worker is performing, and may not protect workers from other workplace hazards, such as spills, or vehicles moving through the workplace. PPE alone may be, therefore, not sufficient to keep workers safe in all situations.

### SUMMARY

In general, the present disclosure describes techniques for forming a social safety network, for creating a network of connected personal protective equipment and for establishing the social safety network on the network of connected PPE.

Conventional workplace communication systems provide limited opportunities for peer-to-peer communication regarding safety issues. This is a disadvantage. Worker-to-worker-led sharing of safety issues provide useful insight into workplace safety; current systems do little, however, to encourage such sharing. The present disclosure describes a communication system that is integrated into an article of personal protective equipment such that safety issue notifications such as safety alerts can be received and shared between peers in the workplace. Peer-to-peer sharing of safety issue ensures the quick dissemination of information regarding safety issues. Such communication may also be studied to determine if current practices in the workplace contribute to safety incidents and can be used therefore to enhance safety. In one approach machine learning is applied to the communication to understand patterns of incidents and events. Such an approach may be useful in curbing repeated safety incidents.

Machine learning may also be applied to a collection of safety alerts and other safety issue notifications representative of workplace safety issues so that the social safety network may begin pushing out or distributing safety issue notifications, to workers and management in the social safety network, based on observations by the social safety network. In some examples, the social safety network distributes safety issue notifications based on the needs/interests of the people involved, based on levels of authority within the safety network, or based on both the needs/interests of the people involved and levels of authority within the safety network.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example system for managing worker communication in a work environment while workers are utilizing personal protective equipment, in accordance with various techniques of this disclosure.

FIG. 2 is a block diagram illustrating a network having five PPEs, all connected via a network protocol, in accordance with various techniques of this disclosure.

FIG. 3 is a block diagram illustrating communication between a PPE and a piece of equipment, in accordance with various techniques of this disclosure.

FIG. 4 is a conceptual diagram illustrating one example approach to a social safety network, in accordance with various techniques of this disclosure.

FIG. 5 is a conceptual diagram illustrating an example article of personal protective equipment, in accordance with various techniques of this disclosure.

FIG. 6 is a conceptual diagram illustrating example operations of an article of personal protective equipment, in accordance with various techniques of this disclosure.

FIG. 7 is a conceptual diagram illustrating an example personal protective equipment management system, in accordance with various techniques of this disclosure.

FIG. 8 is a flowchart illustrating example operations of connected PPEs, in accordance with various techniques of this disclosure.

FIG. 9 is a flowchart illustrating example operations of a social safety network, in accordance with various techniques of this disclosure.

It is to be understood that the embodiments may be used and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

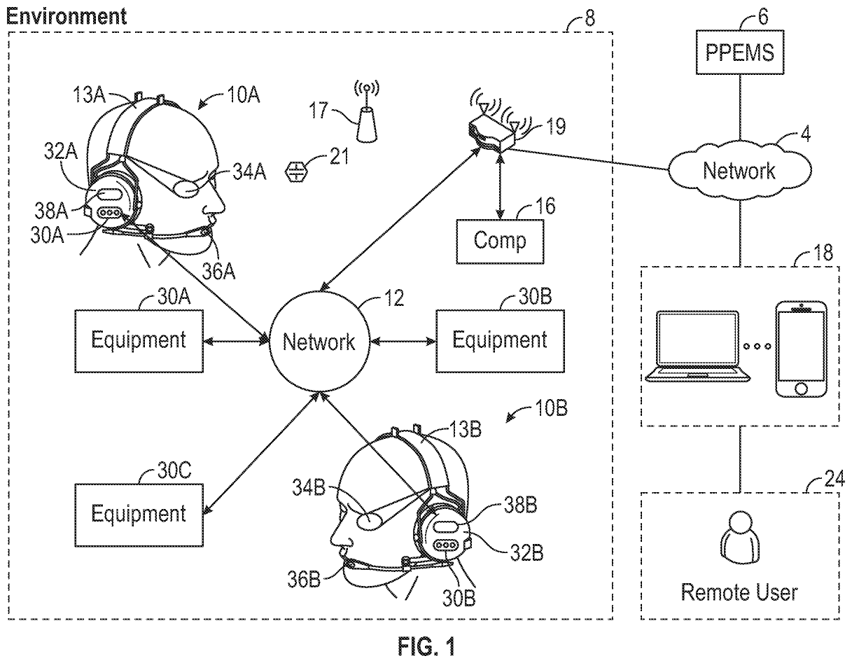

FIG. 1 is a block diagram illustrating an example system 2 of personal protective equipment (PPE) that, when connected together, form a network of connected PPE, according to techniques described in this disclosure. In the example of FIG. 1, system 2 includes a PPE management system (PPEMS) 6 connected through a network 4 to computing devices in work environment 8. Work environment 8 includes a plurality of workers 10A-10B (collectively, workers 10) connected via their PPE 13A-13B (collectively, PPE 13) to network 12 and through network 12 to industrial equipment 30A-30C (collectively, industrial equipment 30).

As shown in the example of FIG. 1, system 2 represents a computing environment in which computing device(s) 16 within work environment 8 electronically communicate with one another and/or with PPEMS 6 via one or more computer networks 4. Computing devices 16 and PPEMS 6 may include a laptop computing device, desktop computing device, a smartphone, server, distributed computing platform (e.g., a cloud computing device), or any other type of computing system.

Work environment 8 represents a physical environment, such as a work environment, in which one or more individuals, such as workers 10, utilize personal protective equipment 13 while engaging in tasks or activities within the respective environment. Examples of environment 8 include a construction site, a mining site, a manufacturing site, among others.

Environment 8 may include one or more pieces of equipment 30A-30C (collectively, equipment 30). Examples of equipment 30 may include machinery, tools, robots, among others. For example, equipment 30 may include HVAC equipment, computing equipment, manufacturing equipment, or any other type of equipment utilized within a physical work environment. Equipment 30 may be moveable or stationary.

In the example of FIG. 1, PPE 13 may include head protection. As used throughout this disclosure, head protection may refer to any type of PPE worn on the worker's head to protect the worker's hearing, sight, breathing, or otherwise protect the worker. Examples of head protection include respirators, welding helmets, earmuffs, eyewear, or any other type of PPE that is worn on a worker's head. As illustrated in FIG. 1, PPE 13A includes inputs 31A, speakers 32A, display device 34A, and microphone 36A while PPE 13B includes inputs 31B, speakers 32B, display device 34B, and microphone 36B.

Each article of PPE 13 may include one or more input devices for receiving input from the worker 10 associated with the PPE 13. In some example approaches, the input devices include worker-actuated inputs such as buttons or switches (e.g., inputs 31A and 31B, collectively “inputs 31”).

Each article of PPE 13 may include one or more output devices for outputting data to the worker that is indicative of operation of PPE 13 and/or generating and outputting communications to the respective worker 10. For example, PPE 13 may include one or more devices to generate audible feedback (e.g., speaker 32A or 32B, collectively “speakers 32”). As another example, PPE 13 may include one or more devices to generate visual feedback, such as display device 34A or 34C (collectively, “display devices 34”), which may display information on a screen, or via light emitting diodes (LEDs) or the like. As yet another example, PPE 13 may include one or more devices used to convey information to the worker via tactile feedback (e.g., via an interface that vibrates or provides other haptic feedback).

In one example approach, each article of PPE 13 is configured to communicate data, such as sensed motions, events and conditions, over network 12 via wireless communications, such as via a time division multiple access (TDMA) network or a code-division multiple access (CDMA) network, or via 802.11 WiFi® protocols, Bluetooth® protocol or the like. In one example approach, one or more articles of PPE 13 communicate with assigned pieces of equipment 30 using a two-way inaudible communications protocol as will be discussed in greater detail below. In some example approaches, one or more of the PPEs 13 communicate directly with a wireless access point 19, and through wireless access point 19 to PPEMS 6.

In general, each of work environments 8 include computing facilities (e.g., a local area network) by which computing devices 16, sensing stations 21, beacons 17, and/or PPE 13 are able to communicate with PPEMS 6. For examples, environments 8 may be configured with wireless technology, such as 802.11 wireless networks, 802.15 ZigBee networks, and the like. Environment 8 may include one or more wireless access points 19 to provide support for wireless communications. In some examples, environment 8 may include a plurality of wireless access points 19 that may be geographically distributed throughout the environment to provide support for wireless communications throughout the work environment. In some examples, PPEs 13 are mesh network nodes that form network 12 as a mesh network. In some such example approaches, the mesh network of network 12 includes mesh network nodes made up of PPEs 13 and one or more pieces of equipment 30, one or more beacons 17, or the like.

As shown in the example of FIG. 1, environment 8 may include one or more wireless-enabled beacons 17 that provide location data within the work environment. In one example approach, beacon 17 may be GPS-enabled such that a controller within the respective beacon 17 may be able to precisely determine the position of the respective beacon. Based on wireless communications with one or more of beacons 17, an article of PPE 13 is configured to determine the location of the worker wearing the article of PPE 13 within environment 8. In this way, event data reported to PPEMS 6 may be stamped with positional data to aid analysis, reporting and analytics performed by PPEMS 6.

In another example approach, each PPE 13 in network 12 is GPS-enabled such that a controller within the respective PPE 13 may be able to precisely determine the position of the worker wearing the respective article of PPE 13 within environment 8. In this way, event data reported to PPEMS 6 may be stamped with positional data to aid analysis, reporting and analytics performed by PPEMS 6. Other approaches to determining the location of workers 10 in work environment 8 include estimating a worker's position based on proximity to fixed pieces (e.g., beacons 17 and equipment 30) within work environment 8.

In addition, environment 8 may include one or more wireless-enabled sensing stations 21. Each sensing station 21 includes one or more sensors and a controller configured to output environmental data indicative of sensed environmental conditions within work environment 8. Moreover, sensing stations 21 may be positioned at fixed locations within respective geographic regions of environment 8 or may be positioned to otherwise interact with beacons 17 to determine respective positions of each sensing station 21 and include such positional data when reporting environmental data to PPEMS 6. As such, PPEMS 6 may be configured to correlate the sensed environmental conditions with the particular regions and, therefore, may utilize the captured environmental data when processing event data received from PPE 13 and/or sensing stations 21. For example, PPEMS 6 may utilize the environmental data to aid generating alerts or other instructions for PPE 13 and for performing predictive analytics, such as determining any correlations between certain environmental conditions (e.g., heat, humidity, visibility) with abnormal worker behavior or increased safety events. As such, PPEMS 6 may utilize current environmental conditions to aid prediction and avoidance of imminent safety events. Example environmental conditions that may be sensed by sensing stations 21 include but are not limited to temperature, humidity, presence of gas, pressure, visibility, wind and the like. Safety events may refer to heat related illness or injury, cardiac related illness or injury, or eye or hearing related injury or illness, or any other events that may affect the health or safety of a worker.

Remote users 24 may be located outside of environment 8. Users 24 may use computing devices 18 to interact with PPEMS 6 (e.g., via network 4) or communicate with workers 10. For purposes of example, computing devices 18 may be laptops, desktop computers, mobile devices such as tablets or so-called smart phones, or any other type of device that may be used to interact or communicate with workers 10 and/or PPEMS 6. Users 24 may interact with PPEMS 6 to control and actively manage many aspects of PPE 13 and/or equipment 30 utilized by workers 10, such as accessing and viewing usage records, status, analytics and reporting. For example, users 24 may review data acquired and stored by PPEMS 6. The data acquired and stored by PPEMS 6 may include data specifying task starting and ending times, changes to operating parameters of an article of PPE 13, status changes to components of an article of PPE 13 (e.g., a low battery event), motion of workers 10, environment data, and the like. In addition, users 24 may interact with PPEMS 6 to perform asset tracking and to schedule maintenance events for individual article of PPE 13 or equipment 30 to ensure compliance with any procedures or regulations. PPEMS 6 may allow users 24 to create and complete digital checklists with respect to the maintenance procedures and to synchronize any results of the procedures from computing devices 18 to PPEMS 6.

PPEMS 6 provides an integrated suite of personal safety protection equipment management tools and implements various techniques of this disclosure. That is, PPEMS 6 provides an integrated, end-to-end system for managing personal protection equipment, e.g., PPE, used by workers 10 within one or more physical environments 8. The techniques of this disclosure may be realized within various parts of system 2.

PPEMS 6 may integrate an event processing platform configured to process thousand or even millions of concurrent streams of events from digitally enabled devices, such as equipment 30, sensing stations 21, beacons 17, and/or PPE 13. An underlying analytics engine of PPEMS 6 may apply models to the inbound streams to compute assertions, such as identified anomalies or predicted occurrences of safety events based on conditions or behavior patterns of workers 10.

Further, PPEMS 6 may provide real-time alerting and reporting to notify workers 10 and/or users 24 of any predicted events, anomalies, trends, and the like. The analytics engine of PPEMS 6 may, in some examples, apply analytics to identify relationships or correlations between worker data, sensor data, environmental conditions, geographic regions and other factors and analyze the impact on safety events. PPEMS 6 may determine, based on the data acquired across populations of workers 10, which particular activities, possibly within certain geographic region, lead to, or are predicted to lead to, unusually high occurrences of safety events.

In this way, PPEMS 6 tightly integrates comprehensive tools for managing personal protective equipment with an underlying analytics engine and communication system to provide data acquisition, monitoring, activity logging, reporting, behavior analytics and alert generation. Moreover, PPEMS 6 provides a communication system for operation and utilization by and between the various elements of system 2. Users 24 may access PPEMS 6 to view results on any analytics performed by PPEMS 6 on data acquired from workers 10. In some examples, PPEMS 6 may present a web-based interface via a web server (e.g., an HTTP server) or client-side applications may be deployed to one or more computing devices 16, 18 used by users 24, such as desktop computers, laptop computers, mobile devices such as smartphones and tablets, or the like.

In accordance with techniques of this disclosure, articles of PPE 13A-13B may each include a respective computing device 38A-38B (collectively, computing devices 38) configured to manage worker communications while workers 10A-10B are utilizing PPE 13A-13B within work environment 8. Computing devices 38 may determine whether to output messages to one or more of workers 10 within work environment 8.

In the example of FIG. 1, PPE 13 may enable communication with other workers 10 and/or remote users 24, for example, via inputs 31, speakers 32, display devices 34, and microphones 36. In one example, worker 10A may communicate with worker 10B and/or remote user 24. For example, microphone 36A may detect audio input (e.g., speech) from worker 10A. The audio input may include a message for worker 10B. In some instances, workers 10 may be engaged in a casual conversation or may be discussing work related information, such as working together to complete a task within work environment 8.

In one example approach, computing device 38A receives audio data from microphone 36A, where the audio data includes a message. Computing device 38A outputs an indication of the audio data to another computing device, such as computing device 38B of PPE 38B, computing device 16, computing device 18, and/or PPEMS 6. In some instances, the indication of the audio data includes the audio data. For instance, computing device 38A may output an analog signal that includes the audio data. In another instance, computing device 38A may encode the audio data into a digital signal and outputs the digital signal to computing device 38B. In some examples, the indication of the audio data includes text indicative of the message. For example, computing device 38A may perform natural language processing (e.g., speech recognition) to convert the audio data to text, such that computing device 38A may output a data signal that includes a digital representation of the text. In some scenarios, computing device 38A outputs a graphical user interface that includes the text prior to sending the indication of the audio data to computing device 38B, which may allow worker 10A to verify the accuracy of the text prior to sending.

In one example approach, computing device 38B receives the indication of the audio data from computing device 38A. Computing device 38B may determine whether to output a representation (e.g., visual, audible, or tactile representation) of the message included in the audio data. A visual representation of the message may include text or an image (a picture, icon, emoji, gif, or other image). In some examples, computing device 38B determines whether to output a visual representation of the message based at least in part on a risk level for worker 10B, an urgency level of the message, or both.

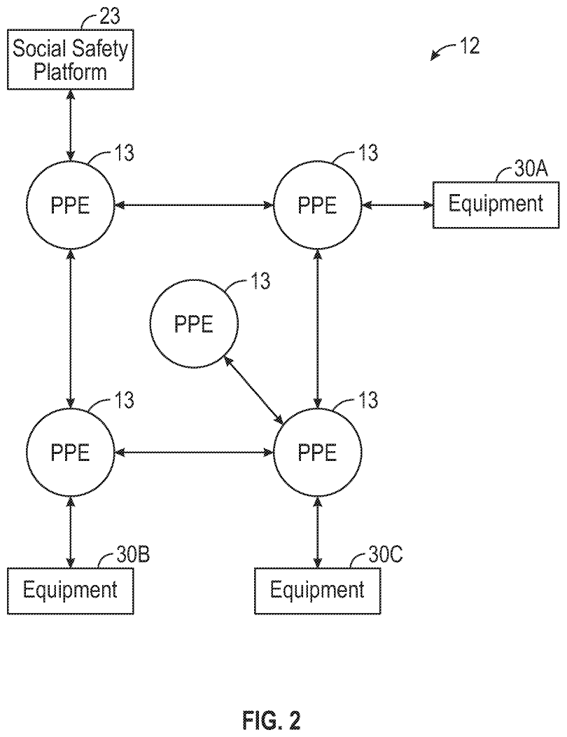

FIG. 2 is a block diagram illustrating a network 12 having five PPEs 13, all connected via a network protocol, in accordance with various techniques of this disclosure. In one example approach, each PPE 13 employs a wireless communications protocol to communicate with one or more other PPEs 13. In some such example approaches, the PPEs 13, together, form network 12. In some example approaches, the wireless communications protocol includes a TDMA network protocol. In some example approaches, the wireless communications protocol includes a code-division multiple access (CDMA) network. In some example approaches, the wireless communications protocol is selected from one or more of an 802.11 WiFi® protocol, a Bluetooth® protocol or the like. In some example approaches, PPEs 13 communicate with selected pieces of equipment 30 over a wireless communications protocol.

In some example approaches, network 12 is a mesh network and each of the PPEs 13 are nodes within the mesh network. In other example approaches, network 12 is a mesh network and the PPEs 13 and one or more of the equipment 30 are mesh network nodes within the mesh network.

By creating a wireless connection between each PPE 13 and the pieces of equipment assigned to the worker using the PPE, one can replace the interface of each piece of equipment 30 with an interface provided by the PPE 13. Such an approach eliminates the requirement that the worker be physically/temporally present at the control panel of the industrial device in order to control or interact with the industrial device.

Systems have been proposed that integrate the industrial control functionality into items such as smartphones or tablets. Such approaches may achieve some of the physical and temporal flexibility of the connected PPE but at the cost of requiring the worker to carry and configure yet another device in addition to their PPE, tools, etc. This adds a burden for a worker to configure/use this extra device and creates additional risk that the worker may forget or misplace the device used to control/interface with the industrial machine. If the worker forgets the device or doesn't use it because it is too cumbersome, it could put worker safety at risk. By integrating this functionality into the PPE, it eliminates the cost of providing the worker with another device and the cost of maintaining such a device.

Furthermore, certain environments require intrinsic safety for all devices to avoid sparking and explosions (such as in environments with explosive gasses). Such environments restrict the types of devices that may be used to control equipment 30.

There are other reasons to favor the integration of machine control with PPE 13. Workers often are donning gloves and other PPE, so working with a device such as a machine interface, a smartphone or a tablet may be difficult. That is, a user may not be able to remove the device from their pocket or operate the interface of the device if they are wearing heavy gloves. Or the user may have to move to a less favorable location to access the machine interface. Integrating the user interface (UI) controls into the industrial machine into PPE 13 itself (e.g., using voice, buttons, bone conduction, head movements, gestures, etc. to control the machine) overcomes this problem and allows the user to quickly and easily interoperate with the equipment 30 while the worker is not near the controls of equipment 30. In one voice-based example approach, PPE 13 includes natural language processing to process voice commands before the commands are conveyed to equipment 30.

Furthermore, moving controls from a machine console or from a device such as a smart phone to PPE 13 may be used to provide more flexibility in handling worker disabilities (e.g., permit the use of gestures instead of voice commands, or the use of speech-to-text instead of aural feedback).

Integrating machine control into PPE 13 allows the PPE (or a separate management system operating in conjunction with PPE 13) to make dynamic changes in the operation of the machine and in the operation of the PPE. For instance, integrating machine control into PPE allows machine control that takes into account the status of PPE 13. That is, if sound exposure for a user wearing a given PPE is reaching a threshold limit, the PPE may limit the machine being used to tasks that can be performed at a reduced sound level. Likewise, if a respirator filter is reaching capacity, tasks may be limited to those that won't tax the respirator filter. A PPE 13 that controls operation of equipment 30 may be used to suspend operation of a machine until safety issues are rectified. The safety issues may be PPE related, machine-related or workplace-related and PPE 13 can be used to suspend operation regardless of the source of the safety issue. Likewise, respirator operation may be controlled to handle increased contaminants due to machine activity.

Integrated controls in the PPE may be used for proximity detection, requiring that the operator be near the machine for the machine to accept certain commands. In one example approach, a worker 10 must be within a predefined distance from the machine in order to operate the machine. Proximity may be based, for instance, on a determination of a location of PPE 13, or may be based on a minimal signal strength between PPE 13 and the machine or other such determination of distance between PPE 13 and the machine to be operated. Integrated controls in the PPE may also be used to enforce geofencing such that the machine turns off if the user moves more than a defined distance away from the machine.

Integrated controls in the PPE may be used to detect when a worker wearing a PPE 13 is perilously close to a machine and to prevent operation of the machine in that situation.

Controls integrated in PPE 13 may be used to detect the direction a user is facing and to propose controls accordingly.

Controls integrated in PPE 13 may be used to track attentiveness on the part of the user of a machine by, for instance, tracking the direction the user is facing or by tracking eye movements. Controls integrated in PPE 13 may also be used to determine when fatigue or other factors (such as intoxication) may be dictating that a break is needed.

Clear and concise communication is fundamental for safety solutions. Current approaches to workplace safety fail to consider the use of PPEs such as PPE 13 to enable tracking, pushing, receiving and anticipating messages of importance. The approaches described in the context of FIGS. 1 and 2 address these shortcomings.

By forming a network 12 from connected PPEs 13 one also creates opportunities for enhanced communication between workers using the connected PPE 13 and provides a mechanism for detecting safety issues early and for conveying each safety issue to the relevant worker or group of workers and/or to management. For instance, by integrating machine controls into the PPE itself (e.g., using voice, buttons, bone conduction, head movements, gestures, etc.), the worker receives ready access to notifications not only from the machine to which the user is assigned but also from other sources. A worker may use PPE 13 receive announcements, to be notified of fire alarms, etc., to be warned about temporary hazards (such as cranes and forklifts moving close by), and to be notified of issues in their machine and in nearby machines (via, for example, the use of the sound emanating from the machine to detect anomalies in machine operation). A worker may also use PPE 13 to receive notifications if, for instance, a worker nearby has become unresponsive or is engaging in risky behavior. Each of these would be difficult to achieve without having the UI integrated into PPE 13.

In addition, by integrating notifications into PPE 13, workers may be exposed to a range of notifications, ranging from very serious to FYI, conveyed with the appropriate urgency to the user. Notifications provided by smart phone or other such devices are easy to put off or ignore.

Furthermore, by integrating notifications into PPE 13, workers may receive notifications customized for the worker. For instance, integrated notifications allow handling of notifications in different ways based on the level of concentration needed by the user. A user that is not interacting with a machine may receive all notifications, while a worker interacting with a machine may receive only a certain subset of notifications and a worker using the machine may receive only safety related notifications. Again, notifications provided by smart phone or other such devices are easy to put off or ignore.

Finally, on-floor supervisors may use controls integrated into PPE 13 (e.g., using voice, bone conduction, head movements, gestures, etc.) to free themselves from a console or data pad. In one example approach, an on-floor supervisor selects between feeds representing what individual workers are seeing on the displays 34. They may use such feeds to, for instance, see what each worker on the floor sees or hear what each worker hears, to monitor each worker's task and safety status, all while moving through the factory floor. In addition, a PPE 13 worn by a supervisor may be used to detect anomalies in machine operation via dynamic sound analysis as they move through the factory floor, or to override a worker's control of a machine when needed.

Intentional communication between workers, the safety management and the automated workplace may be achieved via a social safety network executing on a network of connected PPEs 13. In one example approach, PPEs 13 support safety issue notifications such as safety alerts and other less critical safety notifications. Notifications can easily be shared between peers in the workplace. In a similar way to social media platforms such as Facebook or LinkedIn, workers connected through their PPE 13 push notifications and audible alerts to other workers. Furthermore, the enhanced communication and integrated machine control of PPE 13 may, therefore, be used to establish a situational safety network in which all workers in a location are notified of conditions in the workplace such as safety issues with a particular machine. Such a network may be used, for instance, to coordinate movement of workers reaching safety-related thresholds to different machines or to supervise operation of the machines on the factory floor. Again, notifications by smart phone or other such device are easy to put off or ignore.

In addition to intentional notifications sourced by workers, users and supervisors, in some example approaches, a social safety platform 23 connected to network 12 learns by observing incidents and events and begins to automatically generate notifications and basic safety messages to provide an increase level of awareness within the workplace by anticipating, through a network 12 of connected PPE 13, the safety critical information to be distributed and directed. This connected network of PPEs 13 reduces dependency on current IT infrastructure and provides opportunities to locate, track and trace workers through the social safety network. In one example, social safety platform 23 locates a worker by triangulating on known positional markers within the workplace and on the signal strength of the signal received from the PPE 13 being worn by the worker. In one example approach, alerts are not only pushed or pulled on demand, but also generated by the social safety platform 23 to provide tailored notifications to workers and to safety management.

Peer-to-peer sharing of safety issue ensures the quick dissemination of information regarding safety issues. As noted above, such communication also supports study to determine if current practices in the workplace contribute to safety incidents. In one approach, machine learning is applied to the communication to understand patterns of incidents and events. Such an approach may be useful in curbing repeated safety incidents.

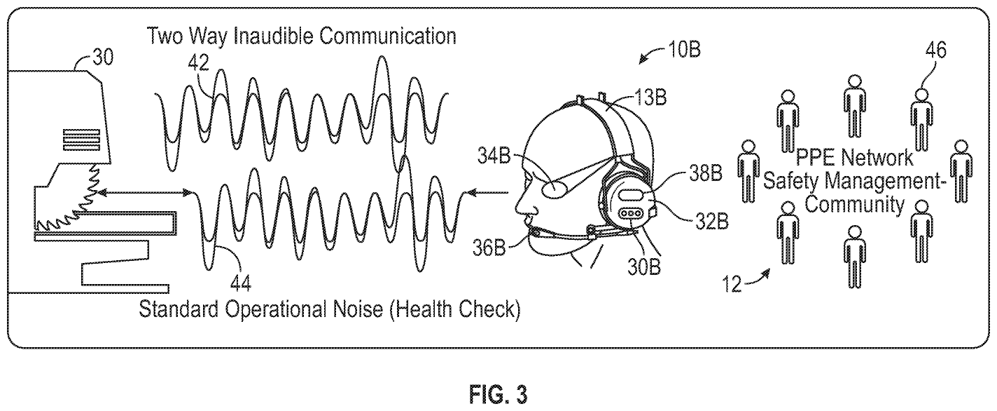

FIG. 3 is a block diagram illustrating communication between a PPE and a piece of equipment, in accordance with various techniques of this disclosure. In the example shown in FIG. 3, PPE 13 is configured to allow the worker to deliver commands via their PPE to the machine or process being run and to receive safety messages through their hearing protection or through other PPE worn by the worker. In one example, the interface includes touch buttons (provided, for example, through input 31) already integrated within PPE 13. In other example approaches, PPE 13 uses inputs such as voice commands or communicates with equipment 30 via gestures detected by the PPE through integrated accelerometers.

In one example approach, computing device 38B uses microphone 36B to listen to sound 44 received from equipment 30 and determines, based on the sound received, whether the equipment 30 is operating correctly. In one such example approach, computing device 38B looks for sounds that indicate wear in an assigned piece of equipment 30 or errors in the adjustment of the assigned piece of equipment 30. In other example approaches, computing device 38B is trained using a machine learning routine to detect problems in equipment 30 based on sound 44.

The approach described above in the discussion of FIGS. 1-3 provides a safety solution that benefits operators and workers who may otherwise be forced to take their eyes from their task and focus their attention elsewhere, even if for short periods of time. For example, the worker may not always be able to focus on an electronic display screen for equipment 30 while performing a task such as drilling a hole or turning a lathe and may, therefore, fail to detect safety critical changes, notifications or warnings from equipment 30. Furthermore, it can be advantageous to not only receive information from equipment 30 via PPE 13 but to also send commands to equipment 30 via PPE 13. For instance, machine operators may benefit from sending a cease command to equipment 30 if they notice a problem developing during a task, or may want to increase or decrease a machine parameter mid-task based on their experience in running the machine. Each of these functions are enabled by a PPE 13 that communicates in the manner described above with an assigned piece of equipment 30. The capability to not only receive notifications from equipment 30 but also to respond to such notifications with commands through connected PPE 13, is a level of interoperability not previously provided in workplace safety solutions.

In the example approach shown in FIG. 3, PPE 13 is connected to a social safety network 46 via network 12. As noted above, the connected network of PPEs 13 reduces dependency on current IT infrastructure and provides opportunities to locate, track and trace workers through social safety network 46. In one example, social safety network 46 locates a worker by triangulating on known positional markers within the workplace and on the signal strength of the signal received from the PPE 13 being worn by the worker. In one example approach, alerts are not only pushed or pulled on demand, but also generated by social safety network 46 to provide tailored notifications to workers and to safety management.

In the example shown in FIG. 3, PPE 13 uses a two-way inaudible communications protocol 42 to control equipment 30 and to receive data from equipment 30 detailing operation and status of equipment 30. In one Data-over-Sound (DoS) approach, the two-way inaudible communications protocol encodes data onto one or more ultrasonic signals.

As noted above, current approaches to workplace safety fail to consider the use of PPE to enable tracking, pushing, receiving and anticipating messages of importance. Furthermore, the current approaches to workplace safety fail to consider the use of data over sound to enable communication between a network of PPEs and between individual PPEs and their assigned equipment 30 in areas where RF communications are restricted or forbidden. The approach described in FIG. 3 addresses these shortcomings.

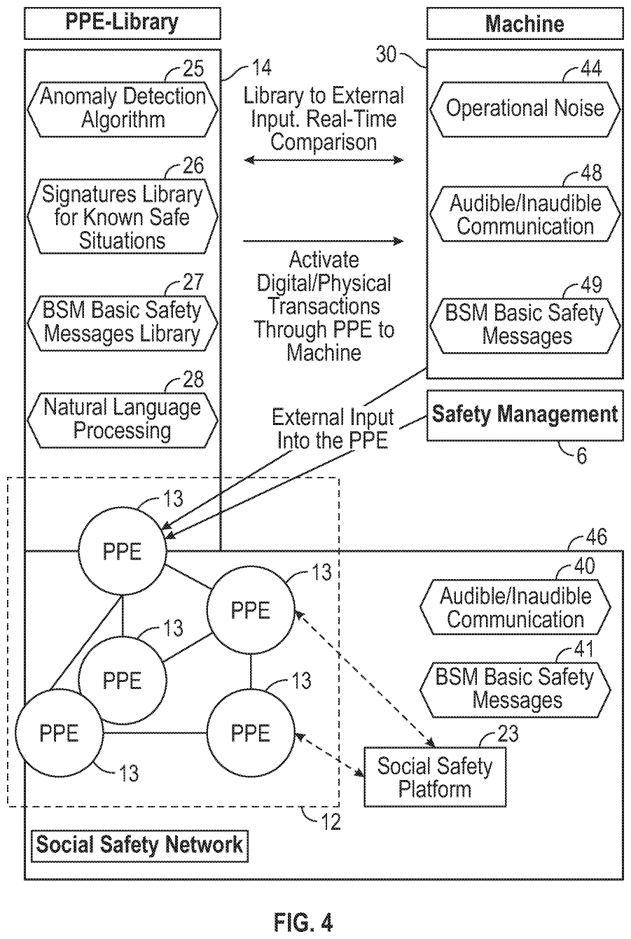

FIG. 4 is a conceptual diagram illustrating one example approach to a social safety network, in accordance with various techniques of this disclosure. In the example approach of FIG. 4, each PPE 13 includes a PPE library 14. PPE library 14 includes routines performed by PPE 13. In one example approach, PPE 13 communicates with equipment 30 via an audible/inaudible communications protocol 48 such as DoS. In some such example approaches, PPE 13 communicates with other PPEs 13 via an audible/inaudible communications protocol 40 such as DoS.

In one example approach, such as is shown in FIG. 4, PPE library 14 includes an anomaly detection routine 25, a signatures library 26, a Basic Safety Messages (BSM) library 27 and a natural language processing routine 28. In one such example approach, anomaly detection routine 25, when executed by PPE 13, receives operation noise data 44 from one or more machines 30 and analyzes the data 44 to detect anomalies in performance of the one or more machines 30 (as, for example, described in the context of FIG. 3 above).

In some example approaches, natural language processing routine 28, when executed by PPE 13, receives recordings of voice commands received at a microphone mounted on PPE 13 and analyzes the recordings using natural language processing (NLP) technologies, parsing and classifying sounds captured within the recording into a set of classes based on semantics of the words. In one example approach, PPE 13 builds a dataset that enables a user to provide feedback on missed classifications. In some example approaches, the dataset is stored in signatures library 26. Such an approach may be used to continually improve NLP as more information becomes available. Some or all of the natural language processing and analysis may be distributed to other PPEs 13, to computing devices 16 or 18, or to PPEMS 6.

In one example approach, signatures library 26 includes patterns associated with voice commands used to control one or more of PPEs 13 and equipment 30. In some such example approaches, the patterns associated with the voice commands are compared to the sound of what appears to be a voice command to determine the command.

In one example approach, signatures library 26 includes patterns of sounds representative of the operational noise of equipment 30. In some such example approaches, the patterns include sounds of machines that are operating within normal parameters and sounds of machines that are not operating within normal parameters.

In one example approach, signatures library 26 stores known safe situations. The signatures in signature library 26 may be known patterns of behaviors or to transactions that may be a cause for concern (similar to credit card fraud). A worker or group of workers may be notified when a pattern has been matched so that the worker or group of workers can avoid a potential hazard. At the same time, any workplace match to one of the patterns/signatures within library 26 may also be brought to the attention of safety management. Further still, such patterns can be used to document near miss situations.

In one example approach, a basic safety message (BSM) library 27 stores known simplified safety messages such that a message code can be used instead of the underlying message for messages between PPE 13 and equipment 30.

In the example approach shown in FIG. 4, a safety management system such as PPEMS 6 operates separately from connected PPE network 12 and communicates to the PPEs 13 of network 12 through one or more of the PPEs 13. In the example shown in FIG. 4, PPEMS 6 provides external input to the PPEs 13. The external input may take the form of configuration information for each PPE, including configuration information defining the interface between the PPE 13 and the machine it is controlling, configuration information defining the user interface presented to the worker through PPE 13, configuration information defining user communications between PPEs 13 and configuration information defining the distribution of safety-related information between the PPEs 13 and between the PPEs 13 and PPEMS 6.

In some example approaches, social safety platform 23 is connected to network 12. As noted in the discussion of FIG. 2 above, in some example approaches, social safety platform 23 learns by observing incidents and events and begins to automatically generate notifications and basic safety messages to provide an increase level of awareness within the workplace by anticipating, through the connected network of PPEs 13, the safety critical information to be distributed and directed. This connected network of PPEs 13 reduces dependency on current IT infrastructure and also provides opportunities to locate, track and trace workers through the social safety network. In one example approach, alerts are not only pushed or pulled on demand, but also generated by the social safety platform 23 to provide tailored notifications to workers and to safety management.

In some example approaches, social safety platform 23 applies machine learning to a collection of safety alerts and other safety issue notifications representative of workplace safety issues and begins pushing out or distributing safety issue notifications, based on its own ‘observations’ or learning, to workers and management in social safety network 46. In some example approaches, social safety platform 23 may employ machine learning to automatically generate and direct safety issue notifications and basic safety messages, such as safety issue notifications and basic safety messages, in order to provide safety critical information that platform 23 anticipates will or should be distributed in the future. In some example approaches, social safety platform 23 distributes safety issue notifications based on the needs/interests of the people involved, based on levels of authority within the safety network, or based on both the needs/interests of the people involved and levels of authority within the safety network.

In some example approaches, known simplified safety messages (e.g., BSMs 41) are used when possible such that a message code can be used to replace the message sent from a PPE 13 to social safety platform 23 or from one PPE 13 to another PPE 13. Such messages, are interpreted at PPE 13 via BSM library 27.

In some example approaches, social safety platform 23 is distributed across the PPEs 13. Such an approach provides redundancy in the event of problems with computer networks in the workplace. In other example approaches, social safety platform 23 is hosted by one of the computing device 16 or by PPEMS 6.

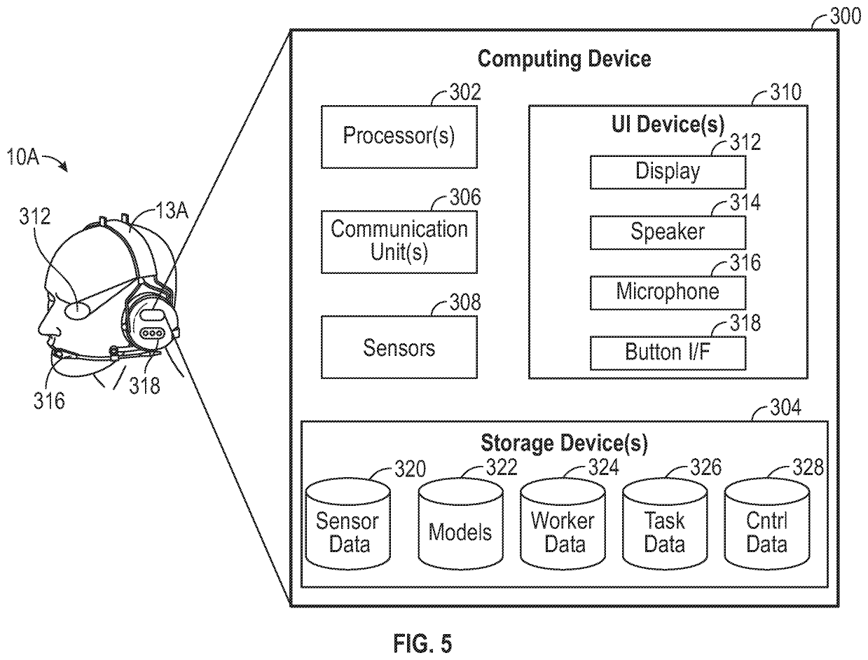

FIG. 5 is a conceptual diagram illustrating an example article of personal protective equipment, in accordance with various techniques of this disclosure. In one example approach, PPE 13A includes head protection that is worn on the head of worker 10A to protect the worker's hearing, sight, breathing, or otherwise protect the worker. In the example of FIG. 5, PPE 13A includes computing device 300. Computing device 300 may be an example of computing devices 38 of FIG. 1.

In the example approach of FIG. 5, computing device 300 may include one or more processors 302, one or more storage devices 304, one or more communication units 306, one or more sensors 308, one or more user interface (UI) devices 310, sensor data 320, models 322, worker data 324, task data 326 and machine control data 328. Processors 302, in one example, are configured to implement functionality and/or process instructions for execution within computing device 300. For example, processors 302 may be capable of processing instructions stored by storage device 304. Processors 302 may include, for example, microprocessors, digital signal processors (DSPs), application specific integrated circuits (ASICs), field-programmable gate array (FPGAs), or equivalent discrete or integrated logic circuitry.

Storage device 304 may include a computer-readable storage medium or computer-readable storage device. In some examples, storage device 304 may include one or more of a short-term memory or a long-term memory. Storage device 304 may include, for example, random access memories (RAM), dynamic random-access memories (DRAM), static random-access memories (SRAM), magnetic hard discs, optical discs, flash memories, or forms of electrically programmable memories (EPROM) or electrically erasable and programmable memories (EEPROM).

In some examples, storage device 304 may store an operating system or other application that controls the operation of components of computing device 300. For example, the operating system may facilitate the communication of data from electronic sensors 308 to communication unit 306. In some examples, storage device 304 is used to store program instructions for execution by processors 302. Storage device 304 may also be configured to store information received or generated by computing device 300 during operation.

Computing device 300 may use one or more communication units 306 to communicate with other PPE 13 in network 12 or in social safety network 46 via one or more wired or wireless connections. Computing device 300 may use one or more communication units 306 to communicate with one or more pieces of equipment 30 via one or more wired or wireless connections or to communicate with wireless access point 19 or computing devices 16 via one or more wired or wireless connections. Communication units 306 may include various mixers, filters, amplifiers and other components designed for signal modulation and demodulation of, for instance, DoS signals, as well as one or more antennas and/or other components designed for transmitting and receiving data.

In some example approaches, communication units 306 within computing device 300 may send data to and receive data from other computing devices 300 using any one or more suitable data communication techniques. In some example approaches, communication units 306 within computing device 300 may send data to and receive data from computing devices 16, computing devices 18 or PPEMS 6 using any one or more suitable data communication techniques. Examples of such communication techniques may include TCP/IP, Ethernet, Wi-Fi®, Bluetooth®, 4G, LTE, and DoS, to name only a few examples. In some instances, communication units 306 may operate in accordance with the Bluetooth Low Energy (BLU) protocol. In some examples, communication units 306 may include a short-range communication unit, such as a near-field communication unit.

In some example approaches, computing device 300 may include one or more sensors 308. Examples of sensors 308 include a physiological sensor, an accelerometer, a magnetometer, an altimeter, an environmental sensor, among other examples. In some examples, physiological sensors include a heart rate sensor, breathing sensor, sweat sensor, etc.

In some example approaches, UI device 310 may be configured to receive user input (via, e.g., microphone 316 or button interface 318) and/or to deliver output information, also referred to as data, to a user (via, e.g., display device 312 or speakers 314). One or more input components of UI device 310 may receive input. Examples of input are tactile, audio, kinetic, and optical input, to name only a few examples. For example, UI device 310 may include a mouse, keyboard, voice responsive system, video camera, buttons, control pad, microphone 316, or any other type of device for detecting input from a human or machine. In some examples, UI device 310 may be a presence-sensitive input component, which may include a presence-sensitive screen, touch-sensitive screen, etc. In other examples, UI device receives proximity signals indicating proximity to another PPE 13, to a beacon 17 or to a piece of equipment 30.

One or more output components of UI device 310 may generate output. Examples of output are data, tactile, audio, and video output. Output components of UI device 310, in some examples, include a display device 312 (e.g., a presence-sensitive screen, a touch-screen, a liquid crystal display (LCD) display, a Light-Emitting Diode (LED) display), an LED, a speaker 314, or any other type of device for generating output to a human or machine. UI device 310 may also include a display, lights, buttons, keys (such as arrow or other indicator keys), and may be able to provide alerts or otherwise provide information to the user in a variety of ways, such as by sounding an alarm or by vibrating.

In some example approaches, communication between PPE 13A and any equipment 30 assigned to PPE 13A or to a worker 10A is defined by data stored in machine control data 328. In some example approaches, machine control data 328 includes a list of commands that can be used by worker 10A when operating equipment 30 assigned to worker 10A. For instance, certain machine control commands may be considered too risky for a less experienced user to use and are, therefore deleted from the permitted command list. In addition, certain machine control commands may be limited to certain conditions. The conditions may be a function of information received from the equipment 30, may be a function of information received from other equipment 30, or from computing devices 16 or 18, or from sensing device 21 or PPEMS 6, or may be determined at PPE 13A based on input from the assigned equipment 30, sensors 308, or an input device such as microphone 316. For instance, certain commands may be inhibited based on information received from the assigned equipment 30. In some example approaches a list of commands and conditional commands are stored in machine control data 328.

In some example approaches, computing device 300 may be configured to manage worker communications while a worker wears an article of PPE that includes computing device 300 within a work environment. For example, computing device 38 may determine whether to present a representation of one or more messages to worker 10A when worker 10a is wearing PPE 13A. In some example approaches, worker 10A logs into computing device 300 of PPE 13A as part of the process of donning PPE 13A.

In some example approaches, computing device 300 receives an indication of a message including audio data from a computing device, such as computing devices 38, PPEMS 6, computing device 16 or computing device 18 of FIG. 1. Computing device 300 may determine whether to output a representation (e.g., visual, audible, or tactile representation) of the message based on information stored in worker data 322 and/or task data 326. In some examples, computing device 300 determines whether to output a visual representation of the message based at least in part on a risk level associated with worker 10A and/or an urgency level of the message.

In some such example approaches, computing device 300 may determine the risk level for worker 10A and/or the urgency level for the message based on one or more rules. In some examples, the one or more rules are stored in models 322. Although other technologies can be used, in some examples, the one or more rules may be generated using machine learning. In other words, storage device 304 may include executable code generated by application of machine learning. The executable code may take the form of software instructions or of rule sets and is generally referred to as a model that can subsequently be applied to data, such as sensor data 320, worker data 324, and/or task data 326 to determine one or more of a risk level associated with worker 10A or an urgency level of the message.

Example machine learning techniques that may be employed to generate models 322 can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbor (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

Models 322 include, in some example, separate models for individual workers, a population of workers, a particular environment, a type of PPE, a type task, or combinations thereof. Computing device 300 may update models 322 based on additional data. For example, computing device 300 may update models 322 for individual workers, a population of workers, a particular environment, a type of PPE, or combinations thereof based on data received from PPE 13, sensing stations 21, or both.

In some example approaches, the models are computed in PPEMS 6. That is, PPEMS 6 determines the initial models and stores the models in models data store 322. Periodically, PPEMS 6 may update the models based on additional data. For example, PPEMS 6 may update models 322 for individual workers, a selected population of workers, a particular environment, a type of PPE, or combinations thereof based on data received from PPEs 13, sensing stations 21, heightened risk in work environment 8, etc.

Computing device 300 may apply one or more models 322 to sensor data 320, worker data 324, and/or task data 326 to determine a risk level for worker 10A. In one example, computing device 300 apply models 322 to a type of task performed by worker 10A and outputs a risk level for worker 10A as a function of worker data 324 and task data 326. As another example, computing device 300 may apply models 322 to sensor data 320 indicative of physiological conditions of worker 10A and output a risk level for worker 10A. For example, computing device 300 may apply models 322 to physiological data generated by sensors 308 to determine the risk level is relatively high when physiological data indicates the worker is breathing relatively hard or has a relatively high heart rate (e.g., above a threshold heart rate). As another example, computing device 300 may apply models 322 to worker data 324 and output a risk level for worker 10A. For example, computing device 300 may apply models 322 to worker data 324 to determine the risk level is relatively low when worker 10A is relatively experienced and determine the risk level is relatively high when worker 10A is relatively inexperienced.

In yet another example, computing device 300 applies models 322 to sensor data 320 and task data 326 to determine the risk level for worker 10A. For example, computing device 300 may apply models 322 to sensor data 320 indicative of environmental characteristics (e.g., decibel levels of the ambient sounds in the work environment) and task data 326 (e.g., indicating a type of task, a location of a task, a duration of a task) to determine the risk level. For instance, computing device 300 may determine the risk level for worker 10A is relatively high when the task involves dangerous equipment (e.g., sharp blades, etc.) and the noise in the work environment is relatively loud.

Computing device 300 may apply one or more models 322 to determine an urgency level of the message. In one example, computing device 300 applies models 322 to the audio characteristics of the audio data to determine the urgency level of the message. For example, computing device 300 may apply models 322 to the audio characteristics to determine that the audio characteristics of the audio data indicate the sender is afraid, such that computing device 300 may determine the urgency level for the message is high.

Computing device 300 may determine the urgency level of the message based on the content of the message and/or metadata for the message. For example, computing device 300 may perform natural language processing (e.g., speech recognition) on the audio data to determine the content of the message. In one example, computing device 300 may perform determine the content of the message and apply one or more of models 322 to the content to determine the urgency level of the message. For example, computing device 300 may determine the content of the message includes casual conversation and may determine based on applying models 322 that the urgency level for the message is low. As another example, computing device 300 applies models 322 to data metadata for the message (e.g., data indicating the sender of the message) and determines the urgency level for the message based on the metadata.

Computing device 300, in some examples, determines whether to output a visual representation of the message based at least in part on the risk level for the worker, the urgency level of the message, or both. For example, computing device 300 may determine whether the risk level satisfies a threshold risk level. In such examples, computing device 300 may determine to output the representation of the message in response to determining the risk level for the worker does not satisfy (e.g., is less than) the threshold risk level. In another example, computing device 300 may determine to refrain from outputting the representation of the message in response to determining the risk level satisfies (e.g., is greater than or equal to) the threshold risk level.

In some scenarios, determines to the representation of the message in response to determining that the urgency level for the message satisfies (e.g., is greater than or equal to) a threshold urgency level. The representation of the message may include a visual representation of the message, an audible representation of the message, a haptic representation of the message, or a combination therein. In one instance, computing device 300 may output a visual representation of the message via display device 312. In another instance, computing device 300 outputs an audible representation of the message via speaker 314. In one example, computing device 300 may determine to refrain from outputting a representation of the message in response to determining that the urgency level for the message does not satisfy (e.g., is less than) the threshold urgency level.

In some examples, computing device outputs the representation of the message as a visual representation in response to determining to output the representation of the message. In one example, computing device 300 determines whether the representation of the message should be a visual representation, an audible representation, or a haptic representation, or a combination thereof. In other words, computing device 300 may determine a type (e.g., audible, visual, haptic) of the output that represents the message.

Computing device 300 may determine the type of the output based on the components of PPE 13A. In one example, computing device 300 determines the type of output includes an audible output in response to determining that computing device 300 includes speaker 314. Additionally, or alternatively, computing device 300 may determine that the type of output includes a visual output in response to determine the computing device 300 includes display device 312. In this way, computing device 300 may output an audible representation of the message, a visual representation of the message, or both.

In some scenarios, computing device 300 determines a type of output based on the risk level of worker 10A and/or the urgency level of the message. In one scenario, computing device 300 compares the risk level to one or more threshold risk levels to determine the type of output. For example, computing device 300 may determine the type of output includes a visual output in response to determining that the risk level for worker 10A includes a “medium” threshold risk level and determine the type of output includes an audible risk level in response to determining the risk level includes a “high” threshold risk level. In other words, in one example, computing device 300 may output a visual representation of the message when the risk level for the worker is relatively low or medium risk. In examples where the risk level is relatively high, computing device 300 may output an audible representation of the message and may refrain from outputting a visual representation of the message.

Computing device 300 may receive a message from a sensing station 21 of FIG. 1, PPEMS 6 of FIG. 1, computing device 16 of FIG. 1, computing device 18 of FIG. 1, equipment 30 of FIG. 1, or other device. Computing device 300 may determine whether to output a representation of the message based on an urgency of the message and/or the risk level for worker 10A. For instance, computing device 300 may determine an urgency level of the message in a manner similar to determining the urgency level for messages received from other workers 10. As one example, computing device 300 may determine whether to output a representation of a message received from an article of equipment 30 based on the urgency level of the message. The message may include data indicating characteristics of the article of equipment 30, such as a health status of the equipment (e.g., “normal”, “malfunction”, “overheating”, among others), usage status (e.g., indicative of battery life, filter life, oxygen levels remaining, among others), or any other information about the operation of equipment 30. Computing device 300 may compare the characteristics to one or more thresholds associated with the characteristics to determine the urgency level of the message. Computing device 300 may output a representation of the message in response to determining the urgency level satisfies a threshold urgency. Additionally, or alternatively, in some instances, computing device 300 may determine whether to output a representation of the message based on the risk level for the worker, as described above.

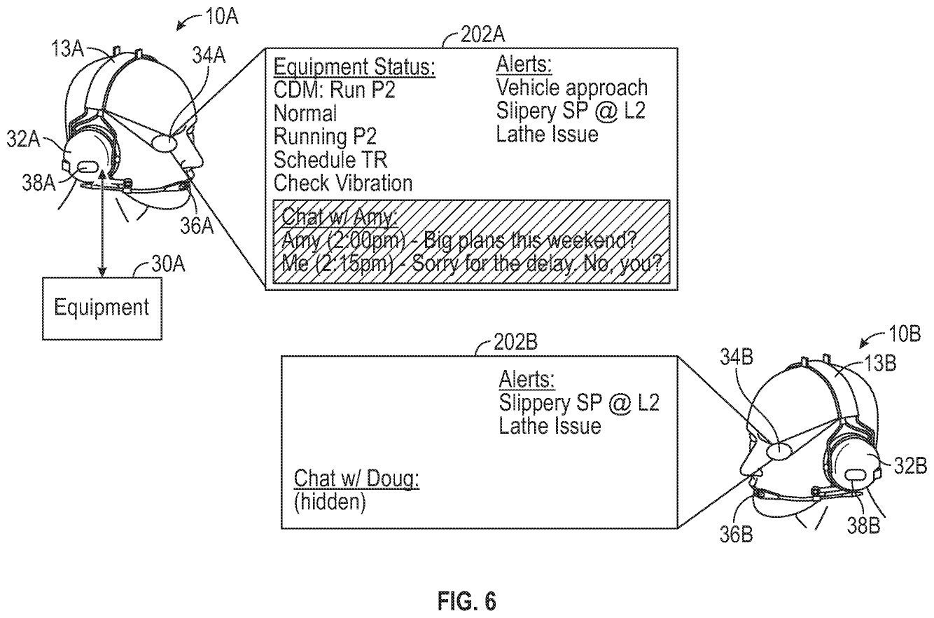

FIG. 6 is a conceptual diagram illustrating example operation of an article of personal protective equipment, in accordance with various techniques of this disclosure. In the example of FIG. 6, workers 10 may communicate with one another using the network 12 formed by connecting PPE 13.

Worker 10B (e.g., Amy) may speak a first message (e.g., “Big plans this weekend?”) to worker 10A (e.g., Doug). Microphone 36B may detect audio input (e.g., the words spoken by worker 10B) and may generate audio data that includes the message. Computing device 38B may output an indication of the audio data to computing device 38A associated with worker 10A. The indication of the audio data may include an analog signal that includes the audio data, a digital signal encoded with the audio data, or text indicative of the first message.

Computing device 38A may determine a risk level for worker 10A. In the example of FIG. 6, computing device 38A determines the risk level for worker 10A is “Low”. Computing device 38A may determine whether to display a visual representation of the first message from worker 10B based at least in part on the risk level for worker 10A. For example, computing device 38A may determine the risk level for worker 10A does not satisfy (e.g., is less than) a threshold risk level. In the example of FIG. 6, computing device 38A determines to output a visual representation of the first message in response to determining the risk level for worker 10A does not satisfy the threshold risk level. For example, computing device 38A may cause display device 34A to display graphical user interface 202A. Graphical user interface 202A may include a text representation of the first message. In some examples, graphical user interface 202A includes a visual representation of the second message. For example, graphical user interface 202 may include messages grouped by the parties involved in the communication (e.g., sender, recipient), topic, etc.

After receiving the first message, microphone 36A may detect a second message spoken by worker 10A (e.g., “Sorry for the delay. No, you?”) and may generate audio data that includes the second message. Computing device 38A may receive the audio data from microphone 36A and output an indication of the audio data to computing device 38B.

In one example, worker 10A is assigned to equipment 30A and receives status from equipment 30A via the interface between PPE 13A and equipment 30A. In one example, worker 10A issues a command “RUN P2” to equipment 30A and the last command is displayed under Equipment status on display 34A. At the same time, in this example, PPE 13A receives status from equipment 30A via the interface between PPE 13A and equipment 30A. In the example shown in FIG. 6, PPE 13A displays status related to equipment 30A. For instance, the status may include a “NORMAL” status indicating the equipment 30A is operating within normal boundaries for the machine. In one example approach, “NORMAL” status is determined by equipment 30A and is received and displayed by PPE 13A. In another example approach, “NORMAL” may be a status determined at PPE 13A from a variety of status parameters received from equipment 30A and/or determined by PPE 13A.

In one example approach, equipment status may include “RUNNING P2” to indicate that equipment 30A is running the task P2 as requested at PPE 13A by worker 10A. The status may also include a recommendation that worker 10A have maintenance check a source of vibration in equipment 30A. In one example approach, status “CHECK VIBRATION” is generated by equipment 30A and displayed on display 34A. In another example approach, status “CHECK VIBRATION” is generated by PPE 13A by detecting vibration in sound 44 generated by equipment 30A as discussed above in the context of FIG. 3.

In the example shown in FIG. 6, the chat window for worker 10A is blanked out when equipment 30A is operating or when other indicia of risk level indicate the chat window should be blanked out.

In one example, as is shown in FIG. 6, current alerts are displayed in an alert window on displays 34A and 34B. In the example shown in FIG. 6, worker 10A has three alerts. The first alert shows a vehicle approaching his location. The second alert indicates that there is a slippery spot at location L2. The third alert indicates that there is an issue with a piece of equipment proximate to worker 10A. At the same time, worker 10B displays alerts relevant to worker 10B. For instance, since worker 10B is not close to the area impacted by the approaching vehicle, the alert is not displayed. The alert indicating that there is a slippery spot at location L2 and the alert indicating that there is an issue with a piece of equipment proximate to worker 10B are still relevant and are displayed on display 34B.

In some example approaches, computing device 38B may determine whether to output a visual indication of the second message based at least in part on a risk level for worker 10B. In the example of FIG. 6, computing device 38B determines the risk level for worker 10B is “Medium”. In some examples, computing device 38B determines to refrain from outputting a visual representation of the second message in response to determining the risk level for worker 10B satisfies (e.g., is greater than or equal to) the threshold risk level.

Computing device 38B may receive an indication of audio data that includes a third message. For instance, computing device 38B may receive the third message from remote user 24 of FIG. 1 (e.g., a supervisor of worker 10B). In some examples, computing device 38B determines whether to output a visual representation of the third message based at least in the risk level for worker 10B and an urgency level for the third message. In the example of FIG. 6, computing device 38B may determine the urgency level for the third message is “Medium”. Computing device 38B may determine a threshold risk level for worker 10B based at least in part on the urgency level of the third message. For example, computing device 38B may determine the threshold urgency level associated with worker 10B's current risk level is a “Medium” urgency level. In such examples, computing device 38B may compare the urgency level for the third message to the threshold urgency level. Computing device may determine to output the visual representation of the third message in response to determining the urgency level for the third message satisfies (e.g., is equal to or greater than) the threshold urgency level. For example, computing device 38B may output the visual representation of the third message by causing display device 34B to output a graphical user interface 202B that includes a representation of the third message. In some instances, as shown in FIG. 6, graphical user interface 202 includes a text representation of the third message. In another instance, graphical user interface 202 may include an image representing the third message (e.g., the visual representation may include an icon such as a storm-cloud when the third message includes information about an impending thunderstorm).

In some examples, the third message includes an indication of a task associated with another worker (e.g., Steve). In the example of FIG. 6, the third message indicates that Steve is performing a task. In such examples, computing device 38B may output, for display, data associated with the third message. In some instances, the data associated with the third images includes a map indicating a location of the task, one or more articles of PPE associated with the task, one or more articles of equipment associated with the task, or a combination thereof. In other words, in one example, graphical user interface 202B may include a map indicating a location of the task performed by another worker, one or more articles of PPE associated with that task, and/or one or more articles of equipment associated with that task.

In one example approach, as shown in FIG. 6, PPE input includes one or more buttons. A worker enters information to be transferred to locations such as equipment 30, other PPEs 13, social safety network 46, and PPEMS 6 by pressing a sequence of the one or more buttons. In one such approach, PPE 13 detects the sequence of button presses and creates a message to be sent to equipment 30, other PPEs 13, social safety network 46, or PPEMS 6 that includes a message code selected from a list of message codes based on the sequence of button presses. In some example approaches, the message code is displayed to the worker for approval before being sent.

In one example approach, the input includes a microphone and PPE 13 interprets sound captured by the microphone to determine information to include in a message. In some example approaches, interpreting sound captured by the microphone includes applying natural language processing to the sound to extract the safety-related information. In other example approaches, interpreting sound captured by the microphone includes detecting issues in equipment in the vicinity of the PPE 13 based on the captured sound and noting the detected issues as safety-related information.

In one example approach, as shown in FIG. 6, PPE 13 is connected to equipment 13 and receives information from equipment 30 regarding, for instance, status. In such an example approach, PPE 13 identifies information to include in a message by reviewing the status and including some or all of the status information in the message.

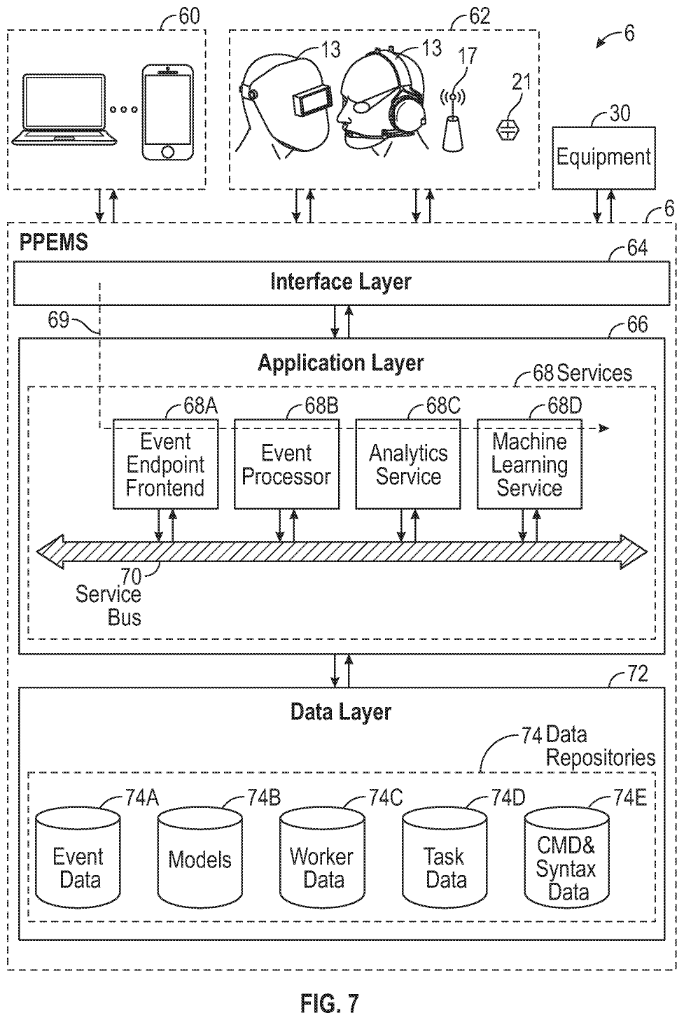

FIG. 7 is a block diagram providing an operating perspective of PPEMS 6 when hosted as cloud-based platform capable of supporting multiple, distinct environments 8 having an overall population of workers 10, in accordance with techniques described herein. In the example of FIG. 7, the components of PPEMS 6 are arranged according to multiple logical layers that implement the techniques of the disclosure. Each layer may be implemented by one or more modules comprised of hardware, software, or a combination of hardware and software.

In FIG. 7, safety equipment 62 include personal protective equipment (PPE) 13, beacons 17, and sensing stations 21. Equipment 30, safety equipment 62, and computing devices 60 operate as clients 63 that communicate with PPEMS 6 via interface layer 64. Computing devices 60 typically execute client software applications, such as desktop applications, mobile applications, and web applications. Computing devices 60 may represent any of computing devices 16 or 18 of FIG. 1. Examples of computing devices 60 may include, but are not limited to a portable or mobile computing device (e.g., smartphone, wearable computing device, tablet), laptop computers, desktop computers, smart television platforms, and servers, to name only a few examples.

Client applications executing on computing devices 60 may communicate with PPEMS 6 to send and receive data that is retrieved, stored, generated, and/or otherwise processed by services 68. The client applications executing on computing devices 60 may be implemented for different platforms but include similar or the same functionality. For instance, a client application may be a desktop application compiled to run on a desktop operating system or a mobile application compiled to run on a mobile operating system. As another example, a client application may be a web application such as a web browser that displays web pages received from PPEMS 6. In the example of a web application, PPEMS 6 may receive requests from the web application (e.g., the web browser), process the requests, and send one or more responses back to the web application. In this way, the collection of web pages, the client-side processing web application, and the server-side processing performed by PPEMS 6 collectively provides the functionality to perform techniques of this disclosure. In this way, client applications use various services of PPEMS 6 in accordance with techniques of this disclosure, and the applications may operate within various different computing environment (e.g., embedded circuitry or processor of a PPE, a desktop operating system, mobile operating system, or web browser, to name only a few examples).

In some examples, the client applications executing at computing devices 60 may request and edit event data including analytical data stored at and/or managed by PPEMS 6. In some examples, the client applications may request and display aggregate event data that summarizes or otherwise aggregates numerous individual instances of safety events and corresponding data obtained from safety equipment 62 and/or generated by PPEMS 6. The client applications may interact with PPEMS 6 to query for analytics data about past and predicted safety events, behavior trends of workers 10, to name only a few examples. In some examples, the client applications may output, for display, data received from PPEMS 6 to visualize such data for users of computing devices 60. As further illustrated and described in below, PPEMS 6 may provide data to the client applications, which the client applications output for display in user interfaces.

As shown in FIG. 7, PPEMS 6 includes an interface layer 64 that represents a set of application programming interfaces (API) or protocol interface presented and supported by PPEMS 6. Interface layer 64 initially receives messages from any of computing devices 60 for further processing at PPEMS 6. Interface layer 64 may therefore provide one or more interfaces that are available to client applications executing on computing devices 60. In some examples, the interfaces may be application programming interfaces (APIs) that are accessible over a network. Interface layer 64 may be implemented with one or more web servers. The one or more web servers may receive incoming requests, process and/or forward data from the requests to services 68, and provide one or more responses, based on data received from services 68, to the client application that initially sent the request. In some examples, the one or more web servers that implement interface layer 64 may include a runtime environment to deploy program logic that provides the one or more interfaces. As further described below, each service may provide a group of one or more interfaces that are accessible via interface layer 64.

In some examples, interface layer 64 may provide Representational State Transfer (RESTful) interfaces that use HTTP methods to interact with services and manipulate resources of PPEMS 6. In such examples, services 68 may generate JavaScript Object Notation (JSON) messages that interface layer 64 sends back to the computing devices 60 that submitted the initial request. In some examples, interface layer 64 provides web services using Simple Object Access Protocol (SOAP) to process requests from computing devices 60. In still other examples, interface layer 64 may use Remote Procedure Calls (RPC) to process requests from computing devices 60. Upon receiving a request from a client application to use one or more services 68, interface layer 64 sends the data to application layer 66, which includes services 68.

As shown in FIG. 7, PPEMS 6 also includes an application layer 66 that represents a collection of services for implementing much of the underlying operations of PPEMS 6. Application layer 66 receives data included in requests received from clients 63 and further processes the data according to one or more of services 68 invoked by the requests. Application layer 66 may be implemented as one or more discrete software services executing on one or more application servers, e.g., physical or virtual machines. That is, the application servers provide runtime environments for execution of services 68. In some examples, the functionality interface layer 64 as described above and the functionality of application layer 66 may be implemented at the same server.

Application layer 66 may include one or more separate software services 68, e.g., processes that communicate, e.g., via a logical service bus 70 as one example. Service bus 70 generally represents logical interconnections or set of interfaces that allows different services to send messages to other services, such as by a publish/subscription communication model. For instance, each of services 68 may subscribe to specific types of messages based on criteria set for the respective service. When a service publishes a message of a particular type on service bus 70, other services that subscribe to messages of that type will receive the message. In this way, each of services 68 may communicate data to one another. As another example, services 68 may communicate in point-to-point fashion using sockets or other communication mechanisms. Before describing the functionality of each of services 68, the layers are briefly described herein.

Data layer 72 of PPEMS 6 represents a data repository that provides persistence for data in PPEMS 6 using one or more data repositories 74. A data repository, generally, may be any data structure or software that stores and/or manages data. Examples of data repositories include but are not limited to relational databases, multi-dimensional databases, maps, and hash tables, to name only a few examples. Data layer 72 may be implemented using Relational Database Management System (RDBMS) software to manage data in data repositories 74. The RDBMS software may manage one or more data repositories 74, which may be accessed using Structured Query Language (SQL). Data in the one or more databases may be stored, retrieved, and modified using the RDBMS software. In some examples, data layer 72 may be implemented using an Object Database Management System (ODBMS), Online Analytical Processing (OLAP) database or other suitable data management system.

As shown in FIG. 7, each of services 68A-68D (collectively, services 68) is implemented in a modular form within PPEMS 6. Although shown as separate modules for each service, in some examples the functionality of two or more services may be combined into a single module or component. Each of services 68 may be implemented in software, hardware, or a combination of hardware and software. Moreover, services 68 may be implemented as standalone devices, separate virtual machines or containers, processes, threads or software instructions generally for execution on one or more physical processors. In some examples, one or more of services 68 may each provide one or more interfaces that are exposed through interface layer 64. Accordingly, client applications of computing devices 60 may call one or more interfaces of one or more of services 68 to perform techniques of this disclosure.

Event endpoint frontend 68A operates as a frontend interface for exchanging communications with equipment 30 and safety equipment 62. In other words, event endpoint frontend 68A operates to as a frontline interface to equipment deployed within environments 8 and utilized by workers 10. In some instances, event endpoint frontend 68A may be implemented as a plurality of tasks or jobs spawned to receive individual inbound communications of event streams 69 that include data sensed and captured by equipment 30 and safety equipment 62. For instance, event streams 69 may include message from workers 10 and/or from equipment 30. Event streams 69 may include sensor data, such as PPE sensor data from one or more PPE 13 and environmental data from one or more sensing stations 21. When receiving event streams 69, for example, event endpoint frontend 68A may spawn tasks to quickly enqueue an inbound communication, referred to as an event, and close the communication session, thereby providing high-speed processing and scalability. Each incoming communication may, for example, carry messages from workers 10, remote users 24 of computing devices 60, or captured data (e.g., sensor data) representing sensed conditions, motions, temperatures, actions or other data, generally referred to as events. Communications exchanged between the event endpoint frontend 68A and safety equipment 62, equipment 30, and/or computing devices 60 may be real-time or pseudo real-time depending on communication delays and continuity.

In general, event processor 68B operates on the incoming streams of events to update event data 74A within data repositories 74. In general, event data 74A may include all or a subset of data generated by safety equipment 62 or equipment 30. For example, in some instances, event data 74A may include entire streams of data obtained from PPE 13, sensing stations 21, or equipment 30. In other instances, event data 74A may include a subset of such data, e.g., associated with a particular time period. Event processor 68B may create, read, update, and delete event data stored in event data 74A.

In accordance with techniques of this disclosure, in some examples, analytics service 68C is configured to manage messages, safety alerts and safety notifications presented to workers in a work environment while the workers are utilizing PPE 13. In one example approach, workers receive safety issue notifications such as safety alerts and safety notifications at times when the safety issue notification is deemed less likely to distract the worker. In some example approaches, workers receive safety issue notifications by balancing the criticality of the safety issue notification with the task the worker is performing. In some such example approaches, safety issue notifications and messages are queued for presentation at a more opportune time to the worker.

Analytics service 68C may include all or a portion of the functionality of PPEMS 6 of FIG. 1, computing devices 38 of FIG. 1, and/or computing device 300 of FIG. 5. Analytics service 68C may determine, for instance, whether to cause an article of PPE 13 utilized by a first worker to output a representation of audio data received from a second worker, alert information generated within network 12 or within social safety network 46, or equipment information relevant to equipment assigned to the first worker. For example, PPEMS 6 may receive an indication of audio data that includes a message from worker 10A of FIG. 1. In some instances, the indication of the audio data includes an analog signal that includes the audio data. In another instance, the indication of the audio data includes a digital signal encoded with the audio data. In yet another instance, the indication of the audio data includes text indicative of the message.

Analytics service 68C may determine rules for determining when to output a representation of a message or a safety issue notification. In some example approaches, Analytics service 68C determines the initial rules for determining when to output a representation of a message or a safety issue notification and stores the rules as models in models data store 74B. Periodically, analytics service 68C may update the models based on additional data. For example, analytics service 68C may update the models for individual workers, a selected population of workers, a particular environment, a type of PPE, or combinations thereof based on data received from PPEs 13, sensing stations 21, heightened risk in work environment 8, etc.

In one example approach, machine learning service 68D generates the rules using machine learning based on combinations of one or more of worker profiles, a history of worker interactions, a history of safety issues in the workplace, current workplace safety rules, and current workplace safety issues. In the example of FIG. 7, the rules are stored in models 74B. Models 74B include, in some example, separate models for individual workers, a population of workers, a particular environment, a type of PPE, a type task, or combinations thereof. Machine learning service 68D may update models 74B as PPEMS 6 receives additional data, such as data received from safety equipment 62, equipment 30, or both. In one example approach, rules are downloaded from models 74B to PPEs 13 based on the worker profile and the environment in which the worker will be operating. The downloaded rules are stored in models 322 of the worker's PPE 13.

At the same time, analytics service 68C may determine whether to output information on alerts relevant to the first worker or information on equipment 30 assigned to the first worker. These rules also may be pre-programmed or be generated using machine learning. In the example of FIG. 7, these rules are stored in models 74B as well. Models 74B include, in some example, separate models for individual workers, a population of workers, a particular environment, a type of PPE, a type task, or combinations thereof. Analytics service 68C may update models 74B as PPEMS 6 receives additional data, such as data received from safety equipment 62, equipment 30, or both.

In some examples, analytics service 68C determines a risk level for the worker based on one or more models 74B. For example, analytics service 68C may apply one or more models 74B derived by machine learning service 68D to event data 74A (e.g., sensor data), worker data 74C, task data 74D, or a combination thereof to determine a risk level for displaying the information to worker 10A.

Analytics service 68C may determine an urgency level for the message based on one or more models 74B. For example, analytics service 68C may apply one or more models 74B to messages and safety issue notifications coming into a PPE 13 and to messages and safety issue notifications generated by a PPE 13. The message rules may take into account audio characteristics in the case of audio data, content of the message, metadata for the message, or a combination thereof. Different models stored in models 74B may be used to determine when and if to display messages, safety issue notifications and equipment notifications.

In some scenarios, analytics service 68C determines whether to output a notification or a representation of the message based at least in part on the risk level for worker 10A, an urgency level of the received message, alert or equipment notification, or both. For example, analytics service 68C may determine whether to output a visual representation of the message based on the risk level and/or urgency level. In another example, analytics service 68C determines whether to output an audible representation of the message based on the risk level and/or urgency level. In some instances, analytics service 68C determines whether to output a visual representation of the message, an audible representation of the message, both an audible representation and a visual representation of the message, or none at all.

Responsive to determining to output a visual representation of the message, analytics service 68C may output data causing display device 34A of PPE 13A to output the visual representation of the message via a GUI. The GUI may include the generated text or may include an image (e.g., icon, emoji, GIF, etc.) indicative of the message. Similarly, analytics service 68C may output data causing speakers 32A of PPE 13A to output an audible representation of the message.

In some example approaches, communication between PPE 13A and any equipment 30 assigned to PPE 13A or to a worker 10A is defined at least in part by data stored in machine control data 328. In some such example approaches, command and syntax data 74E stores commands used to control equipment 30. In some example approaches, analytics service 68C may determine, based in the information stored in machine control data 74E, on one or more models stored in models 74B and on one or more of the worker data stored in worker data 74C and the task data stored in task data 74D, the commands worker 10A is allowed to issue to the equipment assigned to worker 10A. In one approach, machine control data 328 includes a list of commands that can be used by worker 10A when operating equipment 30 assigned to worker 10A. For instance, certain machine control commands may be considered too risky for a less experienced user to use and are, therefore, deleted from the permitted command list. In addition, certain machine control commands may be limited to certain conditions. The conditions may be a function of information received from the equipment 30, may be a function of information received from other equipment 30, or from computing devices 16 or 18, or from sensing device 21 or PPEMS 6, or may be determined at PPE 13A based on input from the assigned equipment 30, sensors 308, or an input device such as microphone 316. For instance, certain commands may be inhibited based on information received from the assigned equipment 30. In some example approaches, analytics service 68C determines list of commands and conditional commands customized for worker 10A and stores the commands and conditional commands in machine control data 328 of PPE 13A.

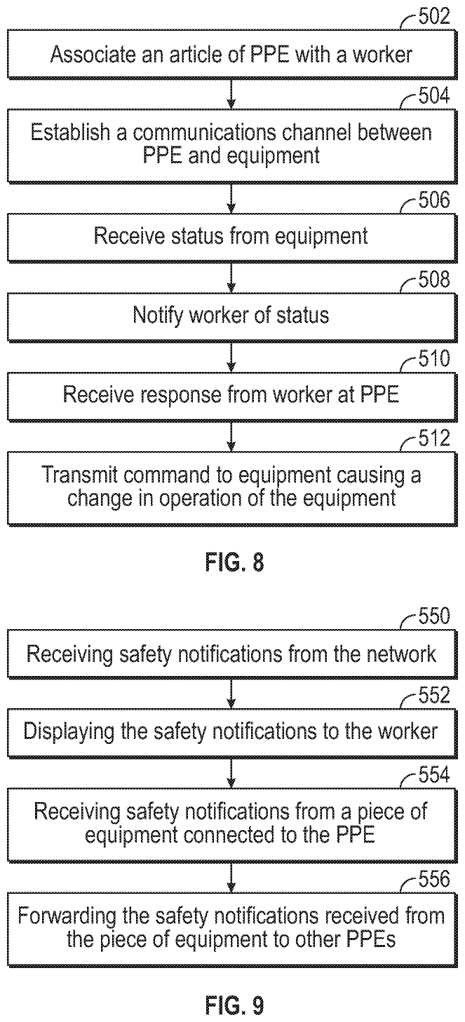

FIG. 8 is a flowchart illustrating example operations of connected PPEs, in accordance with various techniques of this disclosure. FIG. 8 is described below in the context of computing device 38B of PPE 13B worn by worker 10B of FIG. 1. In one example approach, a computing device 38B associates PPE 13B with a worker (502). Computing device 38B establishes a communications channel between the PPE and equipment 30 (504), receives status from equipment 30 (506) and notifies the worker of the received status (508). Computing device 38B receives a response from the worker at the PPE (510) and transmits a command to the equipment 30 causing a change in operation of the equipment based on the response (512).

FIG. 9 is a flowchart illustrating example operations of a social safety network, in accordance with various techniques of this disclosure. FIG. 9 is described below in the context of computing device 38B of PPE 13B worn by worker 10B of FIG. 1. In one example approach, a computing device 38B receives safety issue notifications from the network 12 (550). Computing device 38B displays the safety issue notifications to the worker (552). Computing device 58B then receives safety issue notifications from a piece of equipment connected to the PPE (554) and forwards the received safety issue notifications received from the piece of equipment to other PPES (556).

The social safety network 46 described above improves communication between workers by encouraging workers to share safety issues when they become aware of them. In one example approach, network 46 includes a plurality of articles of personal protective equipment (PPE) 13 connected to form a network of articles of PPE 13. Each article of PPE is associated with a worker. Each PPE is capable of receiving one or more first safety issue notifications from the network, sharing the first safety issue notifications with the worker associated with the article of PPE via an output of the article of PPE, receiving safety-related information at an input of the article of PPE, creating a second safety issue notification based on the safety-related information received at the input of the article of PPE, selecting one or more of the other articles of PPE to receive the second safety issue notification and transmitting the second safety issue notification over the network to the selected articles of PPE.

In some example approaches, social safety network 45 includes a social safety platform connected via the network to the plurality of articles of PPE, wherein the social safety platform observes incidents and events in the work environment and automatically generates safety issue notifications based on the observations based on, for example, machine learning based analysis of safety incidents and events in the workplace.

In some example approaches, social safety network 45 includes a social safety platform connected via the network to the plurality of articles of PPE, wherein the social safety platform observes incidents and events in the work environment and automatically generates tailored safety issue notifications to workers and safety management based on the observations.

In some example approaches, each article of personal protective equipment (PPE), includes an input, and output, and a network interface. Each article of PPE is configured to receive one or more first safety issue notifications on the network interface, to share the first safety issue notifications with the worker associated with the article of PPE via an output of the article of PPE, to receive safety-related information at an input of the article of PPE, to create a second safety issue notification based on the safety-related information received at the input of the article of PPE, to select one or more other articles of PPE to receive the second safety issue notification and to transmit the second safety issue notification via the network interface to the selected articles of PPE. In some example approaches, safety issue notifications include basic safety messages.

In some example approaches, the output is a speaker and the PPE shares the first safety issue notifications with the worker associated with the PPE via the speaker. In some example approaches, the output is a display and the PPE shares the first safety issue notifications with the worker associated with the PPE by displaying the first safety issue notifications within a user interface 202 of the display.

In some example approaches, each PPE 13 includes a display with a user interface. The user interface displays information on one or more of the received first safety issue notification in a first section of the user display and displays communications received from other workers in a second section of the user interface. Such an approach is shown in FIG. 6. In some example approaches, the PPE user interface blanks or otherwise obscures information in the second section of the user interface when necessary to avoid distracting the worker associated with the article of PPE. In some example approaches, each first safety issue notification that is received from the network has a level of criticality and the PPE queues up the received first safety issue notifications below a predefined level of criticality to avoid distracting the worker. In other example approaches, each first safety issue notification that is received from the network has a level of criticality and the PPE queues up first safety issue notifications when the level of criticality of the first safety issue notification falls below a level of criticality assigned to the worker based on the task being performed by the worker.

In one example approach, the input is one or more buttons and PPE 13 receives the safety-related information as a sequence of button presses.

In one example approach, the input is a microphone and PPE 13 receives the safety-related information as sound captured by the microphone.

In one example approach, PPE 13 further includes a communication channel configured to be connected to a piece of equipment. The communication channel establishes two-way communication between PPE 13 and the piece of equipment.

In one example approach, a method of communicating safety issues between PPEs 13 connected by a network and between PPEs 13 and one or more management systems such as PPEMS 6 includes receiving, at a first PPE and via the network, one or more first safety issue notifications, sharing the first safety issue notifications with a worker associated with the first PPE 13 via an output of the first PPE 13, receiving safety-related information at an input of the first PPE 13, creating a second safety issue notification based on the safety-related information received at the input of the first PPE 13, selecting one or more PPEs 13 to receive the second safety issue notification, and transmitting the second safety issue notification via the network from the first PPE 13 to the selected PPEs 13. Each safety issue notification is one or more of a safety alert and a safety notification, wherein each safety alert is a safety critical notification and each safety notification is limited to information that is not safety critical.

In one example approach, the first PPE 13 is connected through a communication channel to a piece of equipment 30 and the first PPE 13 receives, via the network, one or more configuration notifications, wherein each configuration notification includes configuration information used to configure the piece of equipment 30 and the first PPE 13.

In one example approach, the first PPE 13 receives safety-related information at an input of the first PPE 13 requesting that the first PPE 13 forward a selected one of the received first safety issue notifications and the first PPE 13 transmits the selected one of the received first safety issue notifications as part of the second safety issue notification to selected PPEs 13. In one such example approach, the request is a request to forward the selected one of the received first safety issue notifications social safety platform 23 and the first PPE 13 transmits the selected one of the received first safety issue notifications as part of the second safety issue notification to social safety platform 23.

In one example approach, tags are used to highlight particular safety issue notifications received from the network. For instance, in one approach, a worker can add a tag to a selected one of the received first safety issue notifications. In one such approach the tag is transmitted with and the selected one of the received first safety issue notifications to selected PFEs 13 or to social safety platform 23.

In some example approaches, the tags provide an estimate by the worker associated with the first PPE 13 of one or more of the usefulness of the selected one of the received first safety issue notifications, the criticality of the selected one of the received first safety issue notifications, and the extent to which the selected one of the received first safety issue notifications should be shared. In other example approaches, the tag is an indication of if the worker liked the selected one of the received first safety issue notifications.

In some example approaches, a PPE 13 creates second safety issue notification by adding one or more pieces of information to the safety-related information. The one or more pieces of information may be selected from information identifying the worker; information identifying the location of the worker, information identifying the location associated with the safety-related information, information assigning a safety criticality level to the safety-related information, information on the environment in which the worker is operating, status information for the first PPE, and information reflecting physiological measurements of the worker.

In one example approach, the input includes one or more buttons and PPE 13 creates a second safety issue notification that includes a message code selected from a list of message codes displayed on a user interface as a result of a sequence of button presses.

Finally, in some example approaches, social safety platform recommends groupings of workers based on such things as observed interactions between the workers, or on other factors such as the tasks they perform, and sends safety issue notifications to the workers based on their groupings.

Although the methods and systems of the present disclosure have been described with reference to specific exemplary embodiments, those of ordinary skill in the art will readily appreciate that changes and modifications may be made thereto without departing from the spirit and scope of the present disclosure.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

1. A system, comprising:
a plurality of articles of personal protective equipment (PPE) connected to form a network of articles of PPE, wherein each article of PPE is associated with a worker and wherein each article of PPE includes memory and one or more processors, wherein the memory of each article of PPE includes instructions that, when executed by the one or more processors, cause the respective article of PPE to:
receive one or more first safety issue notifications from the network;
share the first safety issue notifications with the worker associated with the article of PPE via an output of the article of PPE;
receive safety-related information at an input of the article of PPE;
create a second safety issue notification based on the safety-related information received at the input of the article of PPE;
select one or more of the other articles of PPE to receive the second safety issue notification; and
transmit the second safety issue notification over the network to the selected articles of PPE.

2. The system of claim 1, wherein the system further includes a social safety platform connected via the network to the plurality of articles of PPE,
wherein the social safety platform observes incidents and events in the work environment and automatically generates safety issue notifications based on the observations.

3. The system of claim 1, wherein the system further includes a social safety platform connected via the network to the plurality of articles of PPE,
wherein the social safety platform observes incidents and events in the work environment and automatically generates tailored safety issue notifications to workers and safety management based on the observations.

4. An article of personal protective equipment (PPE), comprising:
input;
output;
a network interface;
memory; and
one or more processors connected to the input, the output, the network interface and the memory, wherein the memory includes instructions that, when executed by the one or more processors, cause the processors to:
receive one or more first safety issue notifications on the network interface;
share the first safety issue notifications with the worker associated with the article of PPE via an output of the article of PPE;
receive safety-related information at an input of the article of PPE;
create a second safety issue notification based on the safety-related information received at the input of the article of PPE;
select one or more other articles of PPE to receive the second safety issue notification; and
transmit the second safety issue notification via the network interface to the selected articles of PPE.

5. The article of PPE of claim 4, wherein the safety issue notifications include basic safety messages.

6. The article of PPE of claim 4, wherein the output is a speaker and wherein the processors share the first safety issue notifications with the worker associated with the article of PPE via the speaker.

7. The article of PPE of claim 4, wherein the output is a display and wherein the processors share the first safety issue notifications with the worker associated with the article of PPE by displaying the first safety issue notifications within a user interface of the display.

8. The article of PPE of claim 7, wherein the user interface displays information on one or more of the received first safety issue notification in a first section of the user display and wherein the user interface displays communications received from other workers in a second section of the user interface.

9. The article of PPE of claim 8, wherein the processors blank or otherwise obscure information in the second section of the user interface when necessary to avoid distracting the worker associated with the article of PPE.

10. The article of PPE of claim 8, wherein each first safety issue notification has a level of criticality, and
wherein the processors queue up first safety issue notifications below a predefined level of criticality to avoid distracting the worker associated with the article of PPE.

11. The article of PPE of claim 8, wherein each first safety issue notification has a level of criticality, and
wherein the processors queue up first safety issue notifications when the level of criticality of the first safety issue notification falls below a level of criticality assigned to the worker associated with the article of PPE based on the task being performed by the worker.

12. The article of PPE of claim 4, wherein the input is one or more buttons and wherein the processors receive the safety-related information as a sequence of button presses.

13. The article of PPE of claim 4, wherein the input is a microphone and wherein the processors receive the safety-related information as sound captured by the microphone.

14. The article of PPE of claim 4, wherein the article of PPE further includes a communication channel configured to be connected to a piece of equipment, wherein, when connected, the processors establish two-way communication between the article of PPE and the piece of equipment via the communications channel.

15. In a network of connected articles of personal protective equipment (PPE), wherein the articles of PPE include a first article of PPE, a method comprising:
receiving, at the first article of PPE and via the network, one or more first safety issue notifications;
sharing the first safety issue notifications with a worker associated with the first article of PPE via an output of the first article of PPE;
receiving safety-related information at an input of the first article of PPE;
creating a second safety issue notification based on the safety-related information received at the input of the first article of PPE;
selecting one or more articles of PPE to receive the second safety issue notification; and
transmitting the second safety issue notification via the network from the first PPE to the selected articles of PPE.

16. The method of claim 15, wherein each safety issue notification is one or more of a safety alert and a safety issue notification, wherein each safety alert is a safety critical notification and each safety issue notification is limited to information that is not safety critical.

17. The method of claim 15, wherein the first article of PPE is connected through a communication channel to a piece of equipment, wherein the method further comprises:
receiving, at the first article of PPE and via the network, one or more configuration notifications, wherein each configuration notification includes configuration information used to configure one or more of the piece of equipment and the first article of PPE.

18. The method of claim 15, wherein receiving safety-related information at an input of the first article of PPE includes receiving a request to forward a selected one of the received first safety issue notifications, and
wherein transmitting the second safety issue notification includes transmitting the selected one of the received first safety issue notifications to the selected articles of PPE.

19. The method of claim 15, wherein the network includes a social safety platform connected to the articles of PPE,
wherein receiving safety-related information at an input of the first article of PPE includes receiving a request to forward a selected one of the received first safety issue notifications, and
wherein transmitting the second safety issue notification includes transmitting the selected one of the received first safety issue notifications to the social safety platform.

20. The method of claim 15, wherein receiving safety-related information at an input of the first article of PPE includes receiving a tag via the input, the tag associated with a selected one of the received first safety issue notifications.

21-36. (canceled)
